(19) United States
(12) Patent Application Publication
(10) Pub. No.: US 2005/0181340 A1
(43) Pub. Date: Aug. 18, 2005

(54) Adaptive simulation environment particularly suited to laparoscopic surgical procedures

(76) Inventor: Randy S. Haluck, Lititz, PA (US)

Correspondence Address: Douglas L. Wathen;Gifford, Krass, Groh, Sprinkle,, Anderson & Citkowski, P.C., 280 N. Old Woodward Ave., Suite 400, Birmingham, MI, 48009-5394, US

(21) Appl. No.: 11/059,017

(22) Filed: Feb. 16, 2005

Related U.S. Application Data
(60) Provisional application No. 60/545,113, filed on Feb. 17, 2004.

(51) Int. Cl. G09B 19/00; G09B 7/00

(52) U.S. Cl. 434/258

(57) ABSTRACT

A computer-based learning environment automatically increases (or decreases) difficulty in tasks without discrete levels based on performance, thereby maintaining users in an optimal learning “zone,” while accommodating varying levels of skill without frustration or boredom. The method includes the steps of specifying a task to be performed in conjunction with an object; displaying the object in the environment for a predetermined period of time; and modifying the display as a function of the user's ability to complete the task in the predetermined period of time. According to one preferred embodiment, the step of modifying the display includes adjusting the predetermined period of time during which the object is displayed. According to a different preferred embodiment, the step of modifying the display includes changing the size of the object as a function of the user's ability to complete the task. In all embodiments, the step of modifying the display may include changing the color of the object if the user is unable to complete the task in the predetermined period of time, and an audible signal may be generated as a function of the user's ability or inability to complete the task in the predetermined period of time. Though applicable to other learning environments, the adaptive learning environment is ideally suited to surgical skill simulation.

### REFERENCE TO RELATED APPLICATION

This application claims priority from U.S. Provisional Patent Application Ser. No. 60/545,113, filed Feb. 17, 2004, the entire content of which is incorporated herein by reference.

### FIELD OF THE INVENTION

This invention relates generally to computer-based simulators and, in particular, to an adaptive simulation environment that automatically facilitates real-time adjustments based on the user's performance to achieve an optimal learning “zone” involving moderate stress, and further including the ability to change the training environment in real-time to optimize motor-skill learning.

### BACKGROUND OF THE INVENTION

The Yerkes-Dodson principal, also known as the inverted “U” principal, stands for the proposition that in situations of high or low stress, learning and performance are compromised. This presents a major challenge to training, especially for complex tasks and medical procedures. This was confirmed by Moorthy et al. with respect to high stress and laparoscopic task performance.

The Yerkes-Dodson principal further holds that optimal learning and performance occur in a situation of moderate stress. As such, simulators designed for one level of difficulty will not be optimal for some users by virtue of a standard bell curve for a population of learners. For some users, the preset level will be optimal for learning, but low performers may be frustrated or overwhelmed, whereas high performers may become bored or not progress further. It is also known that in situations of high stress, experts will generally increase performance to meet the situation whereas novices may decrease performance, not learn, and not progress.

Computer-based simulators create the possibility of performance recognition, and can adapt a learning environment to a user in real time. However, even computer-based simulators are currently designed with discrete difficulty levels that are selected by the user or an administrator. The need remains, therefore, for a computer-based simulator that automatically adjusts the learning environment as a function of a user's performance to accommodate low, medium and high performers as well as learners with different rates of progression.

### SUMMARY OF THE INVENTION

This invention improves upon and advances the state of the art by providing a learning environment that automatically increases (or decreases) difficulty in tasks without discrete levels. The system and method, called the Smart Tutor, facilitates the real-time adjustments in learning environment based on the user's performance. The algorithm was designed to keep all learners in an optimal learning “zone,” while allowing users of varying levels of abilities to start training without frustration or boredom. Though applicable to other learning environments, the adaptive learning environment is ideally suited to surgical skill simulation.

In a computer-simulated learning environment wherein a user manipulates a virtual object with one or both hands to perform a task, a method according to the invention for adjusting the environment in accordance with the user's performance includes the steps of specifying a task to be performed in conjunction with an object; displaying the object in the environment for a predetermined period of time; and modifying the display as a function of the user's ability to complete the task in the predetermined period of time.

According to one preferred embodiment, the step of modifying the display includes adjusting the predetermined period of time during which the object is displayed. For example, the object may appear for a longer period of time if the user is unable to complete the task in the predetermined period of time, or for a shorter period of time if the user is able to complete the task in the predetermined period of time. For example, the object may appear for a 15-20 percent longer period of time (thus becoming easier and less stressful) if the user is unable to complete the task, or it may appear for a 15-20 percent shorter period of time (more difficult and challenging) if the user is able to complete the task.

According to a different preferred embodiment, the step of modifying the display includes changing the size of the object as a function of the user's ability to complete the task in the predetermined period of time. For example, the size of the object may be increased (easier) if the user is unable to complete the task in the predetermined period of time, or the size may be decreased (more difficult) if the user is able to complete the task in the predetermined period of time.

In all embodiments, the step of modifying the display may include changing the color of the object if the user is unable to complete the task in the predetermined period of time, and an audible signal may be generated as a function of the user's ability or inability to complete the task in the predetermined period of time. If the user uses both hands and the task is not completed, the task is repeated for the same hand, and the task may optionally be adjusted in terms of level of difficulty. If the environment involves a laparoscopic surgical procedure, the task may include grasping, moving, cutting or otherwise manipulating the object.

### BRIEF DESCRIPTION OF THE DRAWINGS

FIG. 1A is a flow diagram indicating important steps according to a speed related method of the invention;

FIG. 1B is a flow diagram indicating important steps according to a speed and accuracy related method of the invention;

FIG. 2A illustrates touching a virtual sphere with a virtual laparoscopic instrument

FIG. 2B illustrates touching a sphere simultaneous with both virtual laparoscopic instrument tips; and

FIG. 2C illustrates grasping of one sphere and transfer to the other grasper.

### DETAILED DESCRIPTION OF THE INVENTION

This invention resides in a learning environment that automatically increases (or decreases) difficulty in tasks without discrete levels. The system and method, called the “Smart Tutor,” facilitates the real-time adjustments in learning environment based on the user's performance. The algorithm was designed to keep all learners in an optimal learning “zone,” while allowing users of varying levels of abilities to start training without frustration or boredom.

The Smart Tutor (ST) software implements a graphical user interface, simulated environment, computer-generated rendering of an environment or scenario, and all key elements represented in that environment. Parameters to be governed by ST may include, but are not limited to, object size, color, speed of motion, timing and frequency or appearance, graphic clarity, haptics, level and types of haptic information, levels of stress to a user of the system, control over which levels, tasks, and scenarios are introduced.

More sophisticated methods to assist in training are further incorporated, certain of which measure user abilities, skill, performance, and proficiency. The system also incorporates various methods of training enhancement such as recognizing saturation effects, plateau effects, after effect, introducing chaining of training tasks, introducing intermittent-type training. Near real-time adjustments are be made, resulting in a unique approach to control of a motor skill training environment.

With respect to a medical/surgical embodiment of the invention, ST is used in combination with RapidFire (Verefi Technologies, Inc. Hershey, Pa.), a PC-based laparoscopic motor-skill trainer using the Immersion Virtual Laparoscopic Interface (Immersion Corporation, San Jose, Calif.). The Smart Tutor software was implemented as a layer of control over all key parameters of the RapidFire environment, including number of trials, left versus right-handed tasks, time parameters, and target sizes.

RapidFire currently implements three tasks, each building skill in succession by a method called forward chaining. With forward chaining a complex series of training tasks is broken down into several, more easily managed sub-tasks. When the first sub-task is mastered, the second is introduced, when one and two together are mastered, the third is added, and so on.

The first RF task is to touch one virtual ball in a virtual space with the tip of a virtual laparoscopic instrument. The virtual laparoscopic instrument is controlled by a mock laparoscopic instrument as part of a simulator hardware input device. The second RF task requires both (two) instrument tips to touch the same ball. The third RF task requires the user to grasp one ball of a dumbbell complex, then transfer the other ball to the other hand.

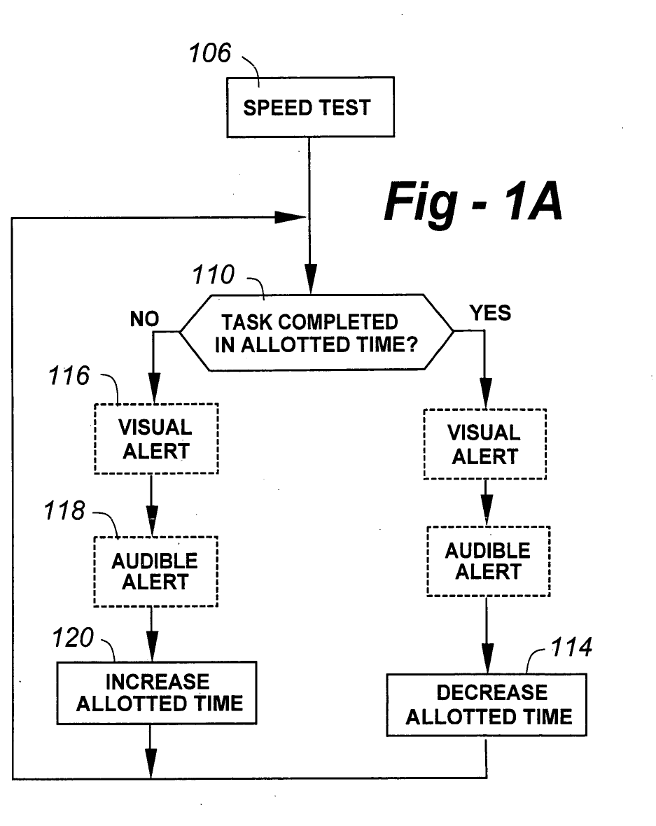

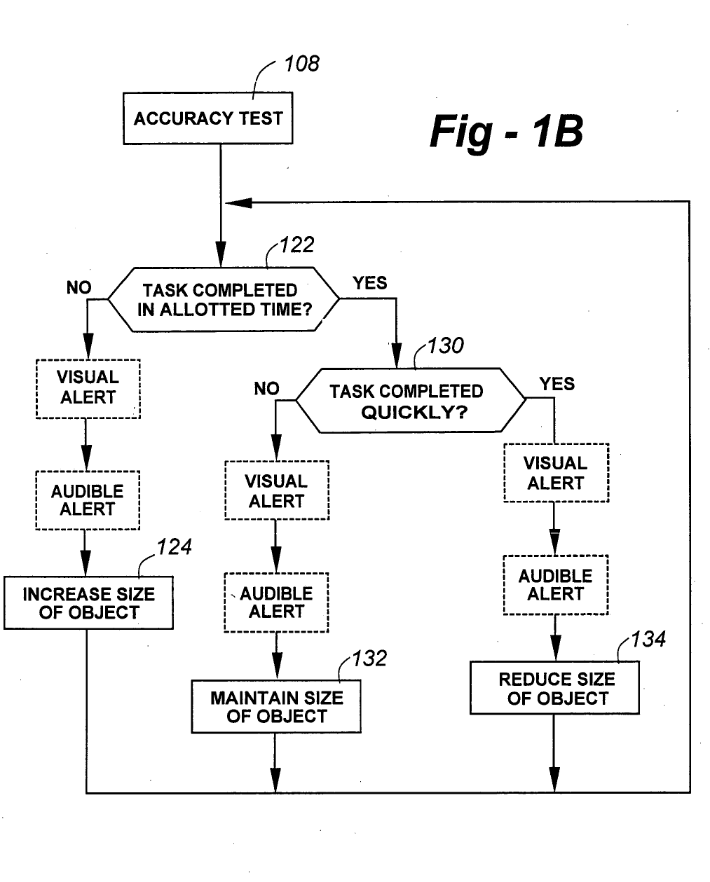

Two different types of ST algorithms are disclosed herein, resulting in six RF/ST tasks in combination. Referring to FIG. 1A, one of these algorithms 106 measures the speed of the user in terms of task completion, and then modifies the speed of subsequent tasks. These are called RF 1,2,3. A second ST algorithm 108 in FIG. 1B (RF 4,5,6) measures the speed of task completion, but then modifies the environment to emphasize the accuracy of subsequent tasks. All RF/ST tasks “train up” the weaker hand, that is if the task is not completed, the task is repeated for the same hand, but may be adjusted in terms of level of difficulty.

The basis for the ST algorithms of RF 1,2,3 is that the target object appears for a preset amount of time, starting at about 2 seconds, for example (though the amount of time may be varied according to the invention depending upon the procedure. See FIG. 1A, decision block 110). If the task in not completed in 2 seconds, the target changes color for a fraction of a second 116 and an auditory signal is generated at 118, signifying failure of that task.

The time that the target is present before the failure signal(s) is then adjusted. For example, if the task is completed in the time the target is present, another visual and/or auditory signal for task completion is given, and the next target time of presence or availability for task completion is reduced by an amount of time at 114, preferably 15-20 percent, making the task more difficult. For a task failure, the duration that the next target is available for task completion by an increase of time at 120 by about 15-20 percent, thus making the task easier. The auditory signals provide immediate (proximate) feedback to help the learner to distinguish between a successfully completed or failed task and are included to assist in learning.

The basis for the ST algorithms for RF 4,5,6 in FIG. 1B is that the target object appears at a variable size and for a set duration. If the user can complete the task at block 122 in a time between 1 and 2 seconds (or thereabouts), the size of the target(s) remains the same at 132 for the next trial. As with all task completion and failure modes, optional visual and/or audible alerts may be generated. If the task is completed quickly at 130, in less than one second or shorter allotted time, the targets become smaller at 134 by a certain percent, making the task more difficult. If the user requires more than 2 second to complete the task, the targets become larger at 124, making the tasks easier. Again, visual and auditory signals for success and failure may be provided.

All of this is done with the intent of optimizing the learning environment for any user. For most users, the difficulty of the trainer starts at roughly a moderate to easy level, but as successes or failure occur, the difficulty of the settings change to a level that is challenging for that particular user. Novices may get worse for several trials then function “in a zone” that is challenging to them. Users with higher abilities or skills will transition to more difficult parameters. We have included graphical representation of users' progress, and we observe a migration from the starting point to the “zone” level after a few trials and the users oscillate in that zone.

A recent improvement was incorporated for use of the invention as a research tool, teaching tool, or part of an Artificial Intelligence or Neural Net control. The new tool has a “graphic equalizer” appearance, and through the use of virtual slide controls, the algorithms can be further modified or biased. For example, rather than reducing the target size by 10 percent, the desired reduction might be 20 percent. The times for target availability and adjustment may be varied. Each task is individually biased so that patterns of difficulty and challenge may be introduced. This allows the system to utilize sounds as motor skill training methods such as plateau effects, saturation, intermittent stressing, and more.

### EXAMPLE AND COMPARISON TO MIST-VR®

To determine the effectiveness of Smart Tutor and RapidFire/Smart Tutor (RF/ST) combination, the invention was compared to the Minimally Invasive Surgery Trainer Virtual Reality (MIST VR, Mentice AB, Sweden), an effective laparoscopic skill training system. Both RF/ST and MIST VR utilize Immersion's Virtual Laparoscopic Interface. The Virtual Laparoscopic Interface consists of two laparoscopic instruments mounted on position-sensing gimbals that provide six degrees of freedom. The computers utilized for the study are Windows XP™ workstations with dual 2.2 Ghz Pentium™ processors and a NVIDIA GeForce™ Open GL graphics accelerator.

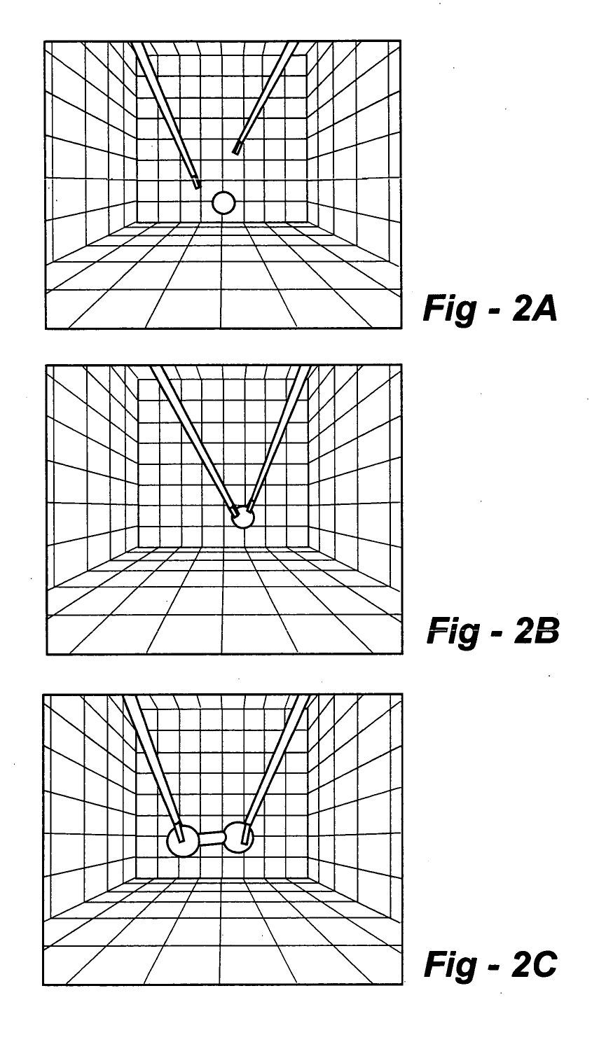

The tasks for the MIST VR simulator include: Acquired Place; Transfer Place and Transversal tasks for medium and master levels. The three RapidFire tasks were: 1. touching a virtual sphere with a virtual laparoscopic instrument (FIG. 2A); 2. touching a sphere simultaneous with both virtual laparoscopic instrument tips (FIG. 2B); and 3. grasping of one sphere and transfer to the other grasper (FIG. 2C). Smart Tutor does not alter the physical functionality of the environment such as the physics of the instruments. Rather, Smart Tutor records performance and makes adjustments in the task environment parameters.

As discussed above, the RapidFire system currently implements six tasks with difficulty levels adjusted during the performance of the task by the Smart Tutor algorithm. Both systems create an accurately scaled 3-D laparoscopic working environment displayed on a 17-inch screen placed at eye level. Both programs can accurately and reliably record the subjects' performance in the various tasks.

This example compares RapidFire/Smart Tutor (RF/ST) combination to MIST-VR for the purpose of examining levels of frustration in training of novices, differences in pre-and post-training assessment between the two systems, and to acquire data for improvements of the Smart Tutor algorithm.

Expert performance criteria (EPC) were established on the (RF/ST) system, the MIST VR medium (MIST VR factory preset) and MIST VR master levels. This was done using the performance of two attending laparoscopic surgeons, a laparoscopic surgery fellow, and two general surgery chief residents. Twenty medical students (year 1 thru 4) were randomized to either the RF/ST or MIST VR simulator. During the training sessions, the medical students were not permitted to train more than 45 minutes in a 24 hour period.

In the RF/ST group, training was completed when subjects achieved EPC in four of the six tasks in two consecutive trials. In the MIST VR group, only the Acquire Place, Transfer Place, and Traversal tasks were used and subjects were advanced from medium to master level when EPC were achieved in two of the three MIST VR tasks for two consecutive trials. In addition, for the MIST VR group, subjects' training was complete once they were able to achieve EPC at master level on two of the three tasks on two consecutive trials. The novice users were assessed by a standard pre- and post-training laparoscopic paper cutting task. Post training, the subjects completed a questionnaire regarding levels of frustration on a five point Likert scale. Data were compared using a standard t-test.

Novice users acquired laparoscopic motor skills on both the RF/ST and MIST VR systems. There was no statistical difference in the medical student school year and the length of time needed to complete training between the two groups. The average percent increase in paper-cutting scores was 14 percent for RF/ST (p=0.05) and 23 percent for MIST VR (p=0.001). The improvement in paper-cutting scores were not significant between RF/ST and MIST VR (p=0.09). The average number of training trails required to achieve EPC on RF/ST and MIST VR environments were 10±3 and 15±4 respectively (p=0.13).

TABLE 1
SUMMARY OF SCORES AND NUMBER OF TRIALS

| | |
|---|---|
| RF/ST (n = 10) | MIST VR (n = 10) |

| | | |
|---|---|---|
| Average Pre-Cutting Score | 15 ± 8.5 | 17 ± 8.3 |
| Average Post-Cutting Score. | 21 ± 7.7 | 28 ± 13 |
| Average Number of Trials to | 10.5 ± 3.4 | 15.4 ± 4.6 |
| Achieve EPC | | |

EPC = Expert Performance Criteria
RF/ST: Rapid Fire/Smart Tutor

The subjects post training survey questions and mean responses+/−standard deviation are outlined in Table 2. A difference in subjective frustration ratings was noted between RF/ST and MIST VR on questions 1 and 3. As demonstrated by questions 4 and 5, no differences were noted when subjects were asked about level of boredom.

TABLE 2
SUMMARY OF POST-TRAINING SURVEY

| | RF/ | MIST | p |
|---|---|---|---|
| Post Training Survey Questions | ST | VR | Value |
| 1. I found training on the simulator to be | 2.0 ± 0.8 | 3.2 ± 1.1 | 0.014 |
| difficult and frustrating. | | | |
| 2. I thought the training on the simulator | 3.8 ± 1.0 | 3.6 ± 1.2 | 0.69 |
| was frustrating/difficult/or challenging | | | |
| at first, but then became easier. | | | |
| 3. I was frustrated with the simulator | 1.6 ± 0.5 | 2.4 ± 1.0 | 0.032 |
| training at one point that I wanted | | | |
| to give-up. | | | |
| 4. I found training on the simulator to be | 1.9 ± 0.9 | 2.3 ± 0.5 | 0.22 |
| boring or tedious. | | | |
| 5. I was bored by the simulation trainer at | 1.6 ± 0.7 | 1.8 ± 0.4 | 0.44 |
| one point and wanted to quit. | | | |

In summary, with the inventive Smart Tutor algorithm applied to the RapidFire simulation environment, novices do learn laparoscopic motor skills with less stress. Though not statistically significant, users of the RF/ST simulators did show a trend towards more rapid acquisition of laparoscopic motor skills than users of the standard MIST VR simulator. Failure to achieve statistical significance is likely attributable to the small test groups.

It is encouraging to note that subjects felt less frustration in training with the RF/ST adaptive system than the MIST VR system with non-adaptive levels. To establish EPC, two of our five experts were chief residents and it is believed that more stringent EPC would have yielded better training, a higher percentage increase from pre- to post paper-cutting scores, less variability in post-training scores within groups, and a better comparison between systems. It is expected that considerable refinement of the adaptive algorithms will be necessary to optimize the systems and that process is underway.

1. In a computer-simulated learning environment wherein a user manipulates a virtual object with one or both hands to perform a task, a method of adjusting the environment in accordance with the user's performance, comprising the steps of:
specifying a task to be performed in conjunction with an object;
displaying the object in the environment for a predetermined period of time; and
modifying the display or task as a function of the user's ability or level of skill.

2. The method of claim 1, wherein the step of modifying the display includes displaying the object for a longer period of time if the user is unable to complete the task in the predetermined period of time.

3. The method of claim 1, wherein the step of modifying the display includes displaying the object for a 15-20 percent longer period of time if the user is unable to complete the task in the predetermined period of time.

4. The method of claim 1, wherein the step of modifying the display includes displaying the object for a shorter period of time if the user is able to complete the task in the predetermined period of time.

5. The method of claim 1, wherein the step of modifying the display includes displaying the object for a 15-20 percent shorter period of time if the user is able to complete the task in the predetermined period of time.

6. The method of claim 1, wherein the step of modifying the display includes increasing the size of the object if the user is unable to complete the task in the predetermined period of time.

7. The method of claim 1, wherein the step of modifying the display includes decreasing the size of the object if the user is able to complete the task in the predetermined period of time.

8. The method of claim 1, wherein the step of modifying the display includes the color of the object if the user is unable to complete the task in the predetermined period of time.

9. The method of claim 1, further including the step of generating an audible signal as a function of the user's ability to complete the task in the predetermined period of time.

10. The method of claim 1, wherein:
the user uses both hands; and
if the task is not completed by one hand, the task is repeated for the same hand.

11. The method of claim 1, wherein:
the user uses both hands; and
if the task is not completed by one hand, the task is repeated for the same hand, and the task is adjusted in terms of level of difficulty.

12. The method of claim 1, wherein the task simulates grasping, moving, cutting or otherwise manipulating the object.

13. The method of claim 1, wherein the task simulates a laparoscopic surgical procedure.
